(19) United States
(12) Patent Application Publication
(10) Pub. No.: US 2025/0016779 A1
(43) Pub. Date: Jan. 9, 2025

(54) UPLINK CONTROL INFORMATION MULTIPLEXING ON PHYSICAL UPLINK SHARED CHANNELS IN NEW RADIO

(71) Applicant: QUALCOMM Incorporated, San Diego, CA (US)

(72) Inventors: Yi HUANG, San Diego, CA (US); Peter GAAL, San Diego, CA (US); Wanshi CHEN, San Diego, CA (US); Sony AKKARAKARAN, Poway, CA (US)

(21) Appl. No.: 18/886,946

(22) Filed: Sep. 16, 2024

Related U.S. Application Data
(62) Division of application No. 16/407,453, filed on May 9, 2019.
(60) Provisional application No. 62/670,617, filed on May 11, 2018.

(51) Int. Cl. H04W 72/21; H04L 1/1829; H04L 5/00; H04W 72/0446; H04W 72/23; H04W 72/51

(52) U.S. Cl. CPC H04W 72/21; H04L 1/1854; H04L 5/0055; H04W 72/0446; H04W 72/51; H04W 72/23

(57) ABSTRACT

Certain aspects of the present disclosure provide techniques for multiplexing uplink control information (UCI) on physical uplink shared channels (PUSCHs) in communications systems operating according to new radio (NR) techniques. In an exemplary method, a UE determines one or more uplink control informations (UCIs); obtains one or more allocations of transmission resources for corresponding physical uplink shared channels (PUSCHs), wherein: a first period of a first allocation of the one or more allocations overlaps a second period during which at least a first UCI of the UCIs is to be transmitted, and the first period and the second period are different; multiplexes the at least the first UCI of the UCIs with the first PUSCH corresponding to the first allocation; and transmits the multiplexed UCIs and the first PUSCH corresponding to the first allocation via the transmission resources of the first allocation.

### CROSS-REFERENCE TO RELATED APPLICATIONS

This application is a divisional of U.S. patent application Ser. No. 16/407,453, filed May 9, 2019, which claims benefit of and priority to U.S. Provisional Patent Application No. 62/670,617, filed May 11, 2018, which are assigned to the assignee hereof and hereby expressly incorporated by reference herein in their entireties as if fully set forth below and for all applicable purposes.

### INTRODUCTION

### Field of the Disclosure

Aspects of the present disclosure relate to wireless communications, and more particularly, to techniques for multiplexing uplink control information (UCI) on physical uplink shared channels (PUSCHs) in communications systems operating according to new radio (NR) techniques.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., which may be referred to as a base station, 5G NB, next generation NodeB (gNB or gNodeB), TRP, etc.). A base station or distributed unit may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. New Radio (NR) (e.g., 5G) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communications that may be performed by a user equipment (UE). The method generally includes determining one or more uplink control informations (UCIs); obtaining one or more allocations of transmission resources for corresponding physical uplink shared channels (PUSCHs), wherein: a first period of a first allocation of the one or more allocations overlaps a second period during which at least a first UCI of the UCIs is to be transmitted, and the first period and the second period are different; multiplexing the at least the first UCI of the UCIs with the first PUSCH corresponding to the first allocation; and transmitting the multiplexed UCIs and the first PUSCH corresponding to the first allocation via the transmission resources of the first allocation.

Certain aspects provide a method for wireless communications that may be performed by a user equipment (UE). The method generally includes determining a time period for one or more uplink control informations (UCIs) for transmission by the UE; determining if the UE has an allocation of transmission resources for a physical uplink shared channel (PUSCH) during a portion of the time period; determining how to multiplex the UCIs based, at least in part, on the allocation of transmission resources for the PUSCH during the portion of the time period; and transmitting the multiplexed UCIs, wherein the UCIs are multiplexed according to the determination how to multiplex the UCIs.

Certain aspects provide a method for wireless communications that may be performed by a user equipment (UE). The method generally includes determining one or more uplink control informations (UCIs); obtaining one or more allocations of transmission resources for corresponding physical uplink shared channels (PUSCHs), wherein: a first period of a first allocation of the one or more allocations overlaps a second period during which at least a first UCI of the UCIs is to be transmitted, the first period and the second period are different, and the first UCI of the UCIs is to be transmitted with repetition in a plurality of the second periods; and transmitting the first UCI of the UCIs with repetition during the plurality of the second periods.

Certain aspects provide an apparatus for wireless communications. The apparatus generally includes a processor configured to determine one or more uplink control informations (UCIs); to obtain one or more allocations of transmission resources for corresponding physical uplink shared channels (PUSCHs), wherein: a first period of a first allocation of the one or more allocations overlaps a second period during which at least a first UCI of the UCIs is to be transmitted, and the first period and the second period are different; to multiplex the at least the first UCI of the UCIs with the first PUSCH corresponding to the first allocation; and to transmit the multiplexed UCIs and the first PUSCH corresponding to the first allocation via the transmission resources of the first allocation; and a memory coupled with the processor.

Certain aspects provide an apparatus for wireless communications. The apparatus generally includes a processor configured to determine a time period for one or more uplink control informations (UCIs) for transmission by the apparatus; to determine if the apparatus has an allocation of transmission resources for a physical uplink shared channel (PUSCH) during a portion of the time period; to determine how to multiplex the UCIs based, at least in part, on the allocation of transmission resources for the PUSCH during the portion of the time period; and to transmit the multiplexed UCIs, wherein the UCIs are multiplexed according to the determination how to multiplex the UCIs; and a memory coupled with the processor.

Certain aspects provide an apparatus for wireless communications. The apparatus generally includes a processor configured to determine one or more uplink control informations (UCIs); to obtain one or more allocations of transmission resources for corresponding physical uplink shared channels (PUSCHs), wherein: a first period of a first allocation of the one or more allocations overlaps a second period during which at least a first UCI of the UCIs is to be transmitted, the first period and the second period are different, and the first UCI of the UCIs is to be transmitted with repetition in a plurality of the second periods; and to transmit the first UCI of the UCIs with repetition during the plurality of the second periods; and a memory coupled with the processor.

Certain aspects provide an apparatus for wireless communications. The apparatus generally includes means for determining one or more uplink control informations (UCIs); means for obtaining one or more allocations of transmission resources for corresponding physical uplink shared channels (PUSCHs), wherein: a first period of a first allocation of the one or more allocations overlaps a second period during which at least a first UCI of the UCIs is to be transmitted, and the first period and the second period are different; means for multiplexing the at least the first UCI of the UCIs with the first PUSCH corresponding to the first allocation; and means for transmitting the multiplexed UCIs and the first PUSCH corresponding to the first allocation via the transmission resources of the first allocation.

Certain aspects provide an apparatus for wireless communications. The apparatus generally includes means for determining a time period for one or more uplink control informations (UCIs) for transmission by the apparatus; means for determining if the apparatus has an allocation of transmission resources for a physical uplink shared channel (PUSCH) during a portion of the time period; means for determining how to multiplex the UCIs based, at least in part, on the allocation of transmission resources for the PUSCH during the portion of the time period; and means for transmitting the multiplexed UCIs, wherein the UCIs are multiplexed according to the determination how to multiplex the UCIs.

Certain aspects provide an apparatus for wireless communications. The apparatus generally includes means for determining one or more uplink control informations (UCIs); means for obtaining one or more allocations of transmission resources for corresponding physical uplink shared channels (PUSCHs), wherein: a first period of a first allocation of the one or more allocations overlaps a second period during which at least a first UCI of the UCIs is to be transmitted, the first period and the second period are different, and the first UCI of the UCIs is to be transmitted with repetition in a plurality of the second periods; and means for transmitting the first UCI of the UCIs with repetition during the plurality of the second periods.

Certain aspects provide a computer-readable medium for wireless communications. The computer-readable medium includes instructions that, when executed by a processor, cause the processor to perform operations generally including determining one or more uplink control informations (UCIs); obtaining one or more allocations of transmission resources for corresponding physical uplink shared channels (PUSCHs), wherein: a first period of a first allocation of the one or more allocations overlaps a second period during which at least a first UCI of the UCIs is to be transmitted, and the first period and the second period are different; multiplexing the at least the first UCI of the UCIs with the first PUSCH corresponding to the first allocation; and transmitting the multiplexed UCIs and the first PUSCH corresponding to the first allocation via the transmission resources of the first allocation.

Certain aspects provide a computer-readable medium for wireless communications. The computer-readable medium includes instructions that, when executed by a processor, cause the processor to perform operations generally including determining a time period for one or more uplink control informations (UCIs) for transmission by an apparatus including the processor; determining if the apparatus has an allocation of transmission resources for a physical uplink shared channel (PUSCH) during a portion of the time period; determining how to multiplex the UCIs based, at least in part, on the allocation of transmission resources for the PUSCH during the portion of the time period; and transmitting the multiplexed UCIs, wherein the UCIs are multiplexed according to the determination how to multiplex the UCIs.

Certain aspects provide a computer-readable medium for wireless communications. The computer-readable medium includes instructions that, when executed by a processor, cause the processor to perform operations generally including determining one or more uplink control informations (UCIs); obtaining one or more allocations of transmission resources for corresponding physical uplink shared channels (PUSCHs), wherein: a first period of a first allocation of the one or more allocations overlaps a second period during which at least a first UCI of the UCIs is to be transmitted, the first period and the second period are different, and the first UCI of the UCIs is to be transmitted with repetition in a plurality of the second periods; and transmitting the first UCI of the UCIs with repetition during the plurality of the second periods.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a frame format for a new radio (NR) system, in accordance with certain aspects of the present disclosure.

FIG. 7 illustrates exemplary techniques for multiplexing two PUCCHs with one PUSCH in a slot, in accordance with certain aspects of the present disclosure.

FIG. 8 is an exemplary scenario in which a PUCCH collides with a first PUSCH and a second PUSCH, in accordance with certain aspects of the present disclosure.

FIG. 9 illustrates an exemplary scenario in which multiple UCIs collide with multiple PUSCHs, in accordance with certain aspects of the present disclosure.

FIG. 10 illustrates exemplary operations for wireless communications, in accordance with certain aspects of the present disclosure.

FIG. 11 illustrates exemplary operations for wireless communications, in accordance with certain aspects of the present disclosure.

FIG. 12 illustrates a communications device that may include various components configured to perform operations for the techniques disclosed herein in accordance with aspects of the present disclosure.

FIG. 13 illustrates an example of handling multiple PUCCHs with a single PUSCH, in accordance with aspects of the present disclosure.

FIG. 14 illustrates an example of handling multiple PUCCHs with a single PUSCH, in accordance with aspects of the present disclosure.

FIG. 15 illustrates an example of UCI multiplexing with slot repetition jointly for each slot.

FIG. 16 illustrates an example of UCI multiplexing with slot repetition independently for each slot.

FIG. 17 illustrates exemplary operations for wireless communications, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for multiplexing uplink control information (UCI) on physical uplink shared channels (PUSCHs) in communications systems operating according to new radio (NR) techniques.

According to aspects of the present disclosure, techniques for UCI multiplexing on PUSCHs without slot aggregation are provided.

In aspects of the present disclosure, techniques for UCI multiplexing on PUSCH with physical uplink control channel (PUCCH) and/or PUSCH repetition are provided.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

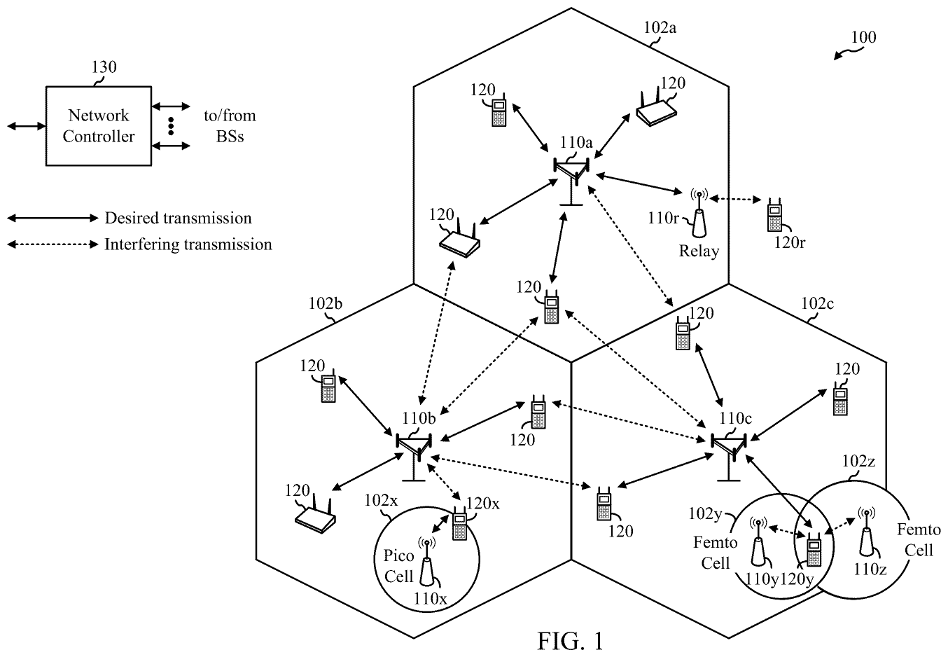

FIG. 1 illustrates an example wireless communication network 100 in which aspects of the present disclosure may be performed. For example, the wireless communication network 100 may be a New Radio (NR) or 5G network.

As illustrated in FIG. 1, the wireless network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B (NB) and/or a Node B subsystem serving this coverage area, depending on the context in which the term is used. In NR systems, the term “cell” and next generation NodeB (gNB), new radio base station (NR BS), 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A base station (BS) may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link Some UEs may be considered Internet-of-Things (IoT) devices, which may be narrowband IoT (NB-IoT) devices.

In aspects of the present disclosure, one or more of the UEs 120 shown FIG. 1 may perform the disclosed techniques to multiplex UCIs on PUSCH without slot aggregation. Additionally or alternatively, one or more of the UEs 120 shown in FIG. 1 may perform the disclosed techniques to multiplex UCIs on PUSCH(s) with PUCCH and/or PUSCH repetition.

Certain wireless networks (e.g., LTE) utilize orthogonal frequency division multiplexing (OFDM) on the downlink and single-carrier frequency division multiplexing (SC-FDM) on the uplink OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled, wherein a. A scheduling entity (e.g., a base station) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink A finely dashed line with double arrows indicates interfering transmissions between a UE and a BS.

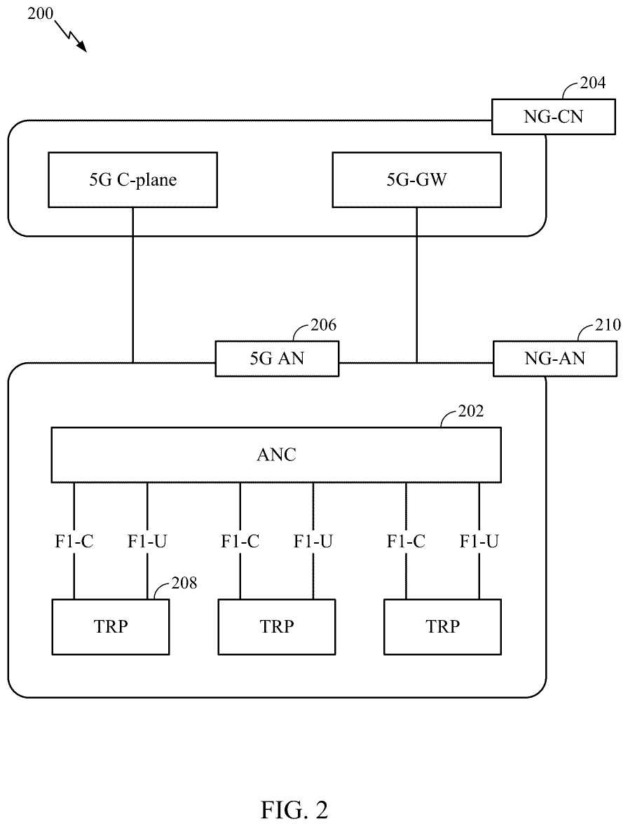

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more transmission reception points (TRPs) 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

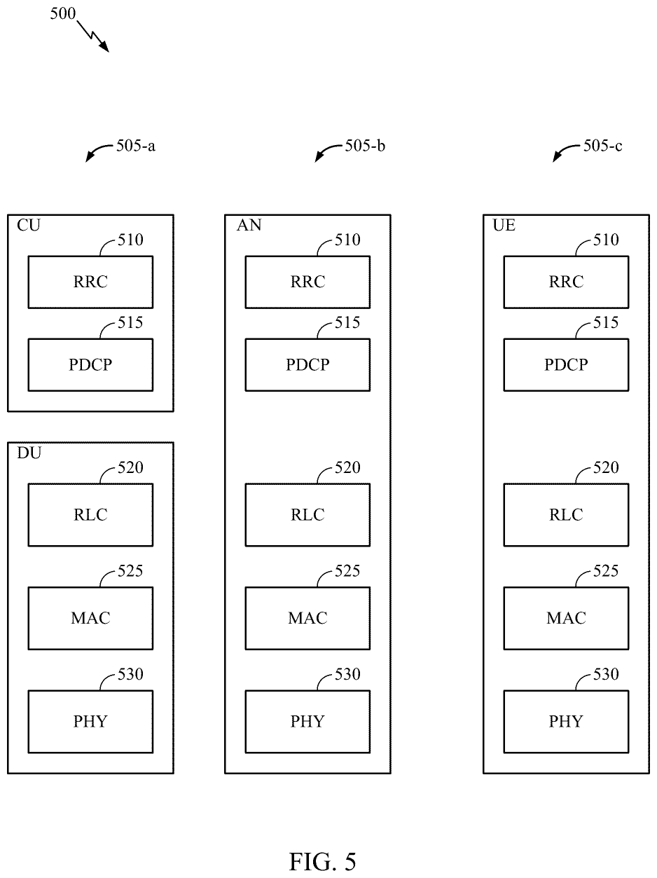

Logical functions may be dynamically distributed in the logical architecture of distributed RAN 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

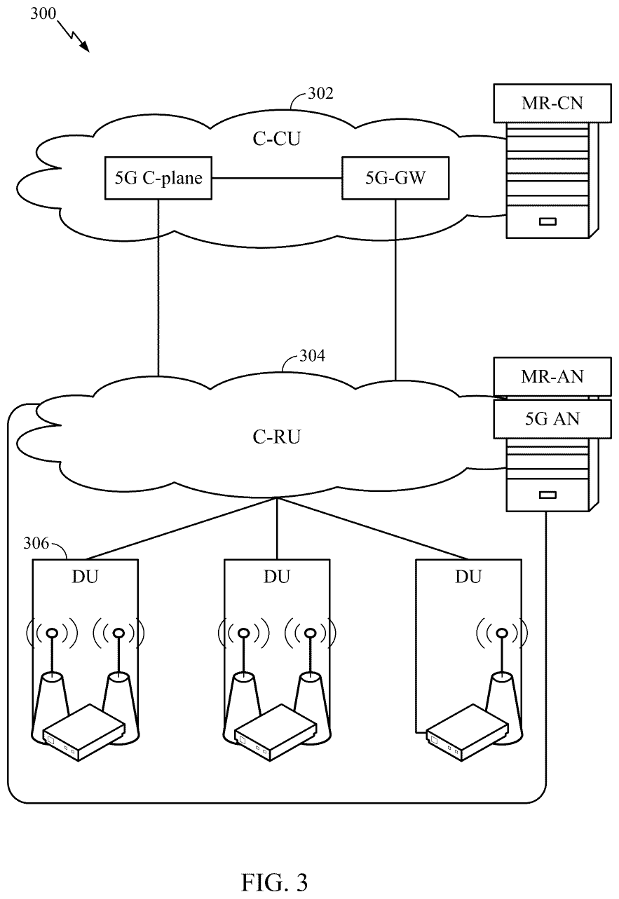

FIG. 3 illustrates an example physical architecture of a distributed Radio Access Network (RAN) 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

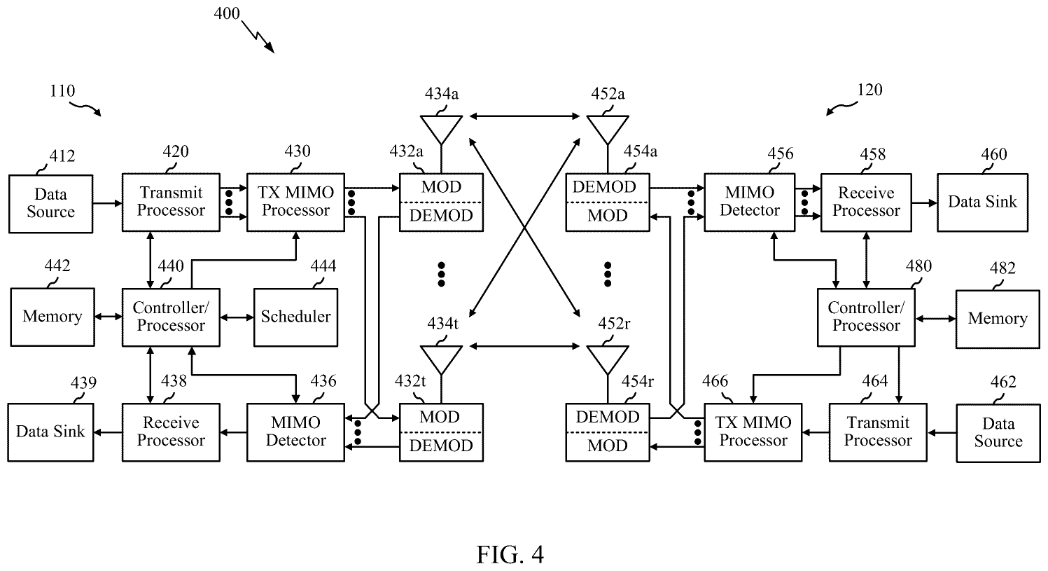

FIG. 4 illustrates example components of BS 110 and UE 120 (as depicted in FIG. 1), which may be used to implement aspects of the present disclosure. For example, antennas 452, processors 466, 458, 464, and/or controller/processor 480 of the UE 120 and/or antennas 434, processors 420, 460, 438, and/or controller/processor 440 of the BS 110 may be used to perform the various techniques and methods described herein for multiplexing UCI on PUSCH without slot aggregation and/or for multiplexing UCI on PUSCH with PUCCH and/or PUSCH repetition.

At the BS 110, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at UE 120, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

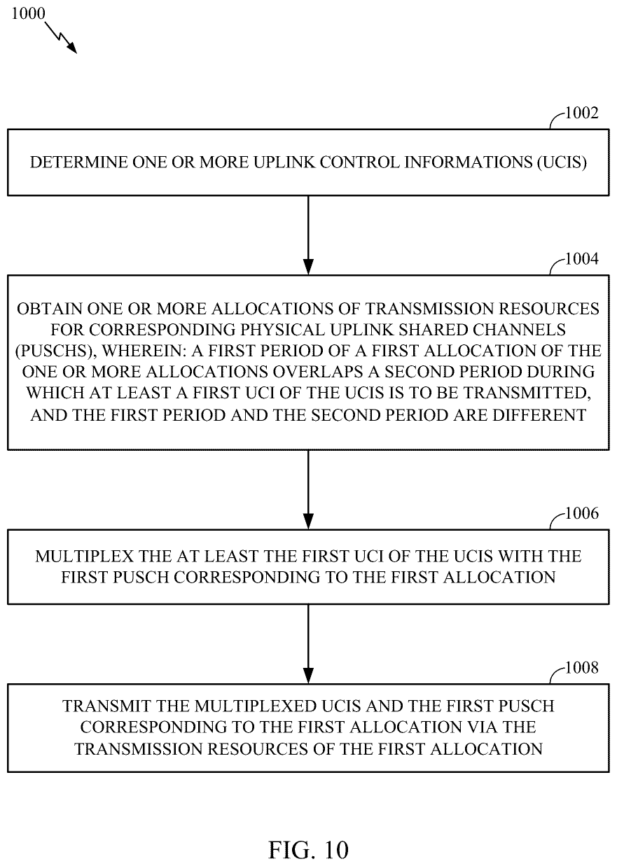

The controllers/processors 440 and 480 may direct the operation at the base station 110 and the UE 120, respectively. The processor 440 and/or other processors and modules at the BS 110 may perform or direct the execution of processes for the operations described in FIGS. 10-11 and 17 and other techniques described herein. The memories 442 and 482 may store data and program codes for BS 110 and UE 120, respectively. The stored data and program codes may enable the BS 110 and/or the UE 120 to perform the operations described in FIGS. 10-11 and 17 and other techniques described herein. A scheduler 444 may schedule UEs for data transmission on the downlink and/or uplink

FIG. 5 illustrates a diagram 500 showing examples for implementing a communications protocol stack, according to aspects of the present disclosure. The illustrated communications protocol stacks may be implemented by devices operating in a wireless communication system, such as a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples, the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device. In the second option, RRC layer 510, PDCP layer 515, RLC layer 520, MAC layer 525, and PHY layer 530 may each be implemented by the AN. The second option 505-b may be useful in, for example, a femto cell deployment.

Regardless of whether a network access device implements part or all of a protocol stack, a UE may implement an entire protocol stack as shown in 505-c (e.g., the RRC layer 510, the PDCP layer 515, the RLC layer 520, the MAC layer 525, and the PHY layer 530).

In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The cyclic prefix (CP) length also depends on the subcarrier spacing.

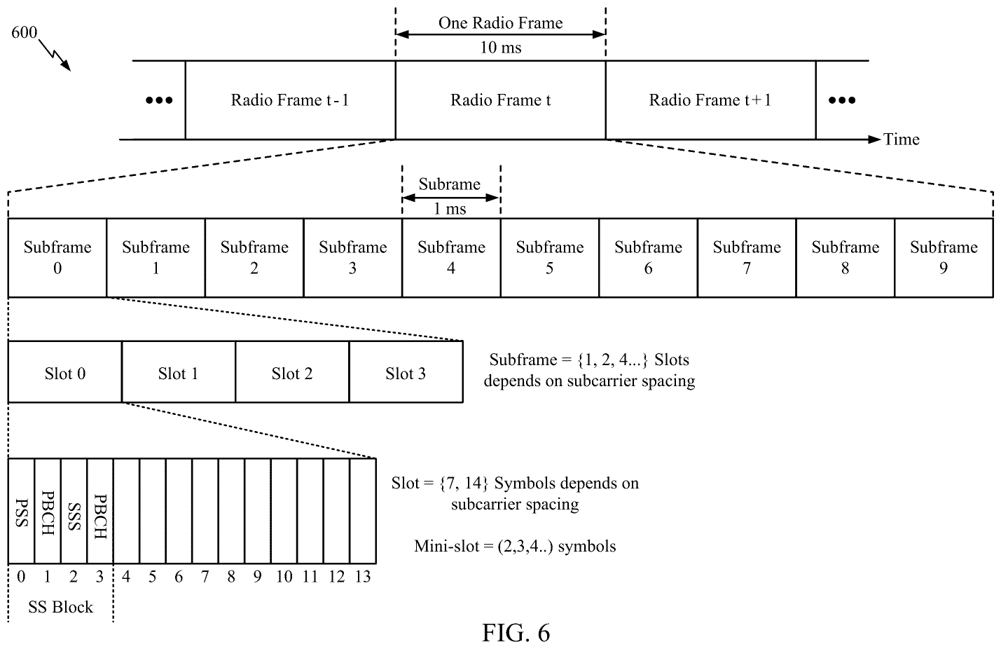

FIG. 6 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot is a subslot structure (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing; the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Uplink Control Information Multiplexing on Physical Uplink Shared Channels in New Radio

In communications systems operating according to new radio (NR) techniques, when a single-slot physical uplink control channel (PUCCH) to be transmitted by a UE overlaps with a single-slot PUCCH or a single-slot physical uplink shared channel (PUSCH) to be transmitted by the UE in slot n for a PUCCH group, the UE may multiplex all uplink control informations (UCIs) on either one PUCCH or one PUSCH, using the existing UCI multiplexing rule, if both of the following conditions are satisfied: 1) the first symbol of the earliest PUCCH(s) and/or PUSCH(s) among all of the overlapping channels starts no earlier than symbol N1+X after the last symbol of any corresponding physical downlink shared channel(s) (PDSCH(s)) to that UE which is acknowledged (ACKed) in slot n; and 2) the first symbol of the earliest PUCCH(s) and/or PUSCH(s) among all the overlapping channels starts no earlier than N2+Y after the last symbol of any physical downlink control channels (PDCCH)s scheduling UL transmissions, including hybrid automatic retransmission request acknowledgment (HARQ-ACK) transmissions and PUSCH (if applicable), for slot n. If one of the two conditions is not satisfied, then a UE may consider this to be an error case for all of the uplink (UL) channels in the group of overlapping channels. In the preceding, N1, N2, X, and Y are required to be non-negative integers. X and Y may be set to 1 to allow one more symbol of processing time for multiplexing.

According to aspects of the present disclosure, techniques for multiplexing multiple PUCCHs that collide with one or multiple PUSCHs are provided.

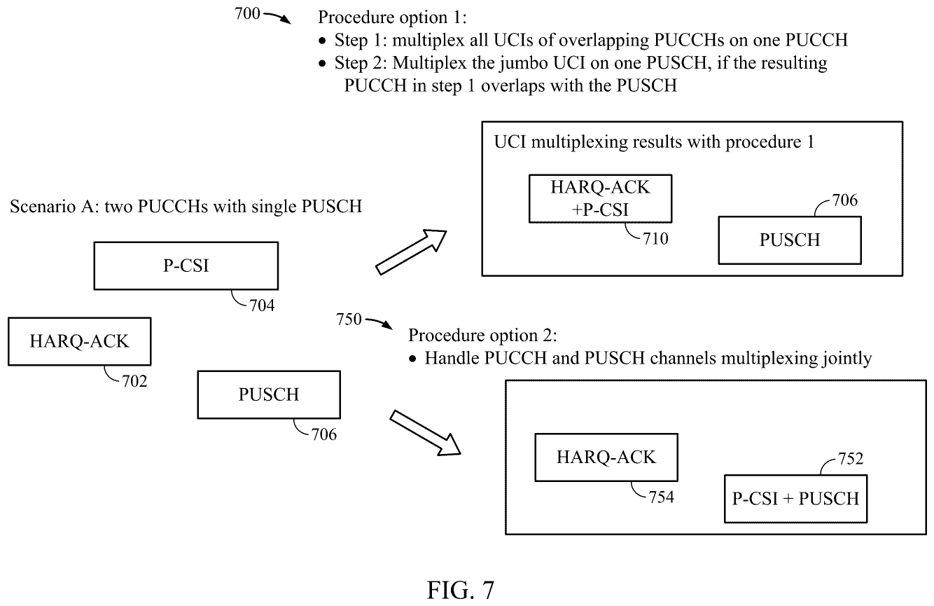

FIG. 7 illustrates two exemplary techniques 700 and 750 for multiplexing two PUCCHs with one PUSCH in a slot. In both exemplary techniques 700 and 750, the UE is scheduled to transmit a UCI 702 that includes a hybrid automatic retransmission request acknowledgment (HARQ-ACK), a UCI 704 that includes periodic channel state information (P-CSI), and a PUSCH 706. In the exemplary technique 700, the UE first multiplexes all UCIs of overlapping PUCCHs (e.g., UCI 702 and 704) into one PUCCH 710. The UE next multiplexes the PUCCH on one PUSCH 706, if the PUCCH 710 resulting from multiplexing the UCIs overlaps the PUSCH 706 in time. Note that as illustrated in technique 700, the PUCCH 710 with all of the multiplexed UCIs is transmitted during the period for transmitting the HARQ-ACK UCI 702, and therefore the PUCCH 710 is not multiplexed with the PUSCH 706 in the illustrated example (because the PUCCH 710 and the PUSCH 706 do not overlap).

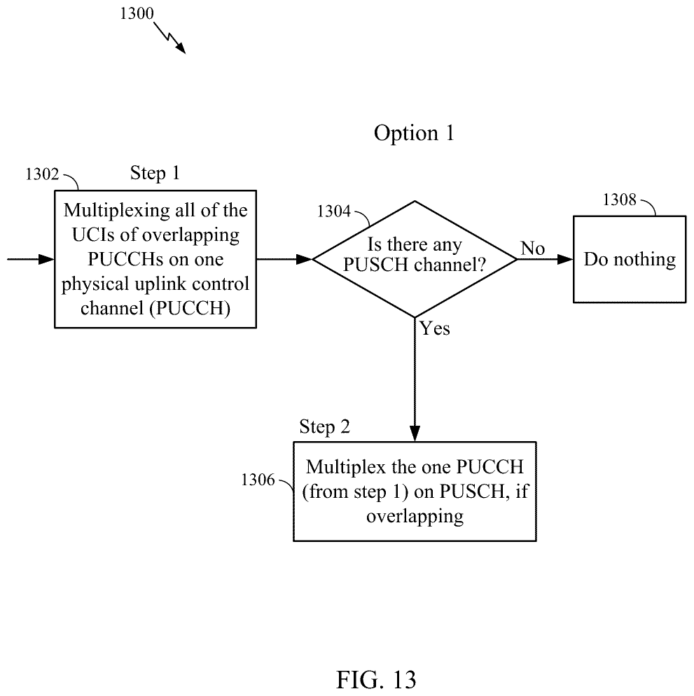

FIG. 13 provides a flow chart illustrating example operations 1300 for technique 700. At block 1302, the UE multiplexes all of the overlapping UCIs (e.g., overlapping in the time domain) into one PUCCH. The UE determines at block 1304 if there is an allocation for transmission on the PUSCH. If yes, at block 1306, the UE determines if the multiplexed PUCCH (from block 1302) overlaps with the PUSCH (i.e., the PUSCH mentioned in block 1304). If there is overlap, the UE multiplexes the multiplexed PUCCH (from block 1302) with the PUSCH (from block 1304). If there is not an allocation for transmission on the PUSCH at block 1304, then does nothing else to multiplex the UCIs with any PUSCH, as shown at block 1308.

Referring again to FIG. 7, in the exemplary technique 750, the UE multiplexes UCIs individually with PUSCHs that are transmitted in overlapping periods. Thus, in the illustrated example, a UE using the technique 750 multiplexes the UCI 704 with the PUSCH 706 to generate a multiplexed UCI plus data PUSCH 752. Because the UCI 702 including the HARQ-ACK does not overlap the PUSCH 706 in time, the UCI 702 is transmitted in a PUCCH 754 independently of the transmission of the PUSCH 752.

Note that if there is no PUSCH to be transmitted, then a UE may multiplex all UCIs which are to be transmitted at overlapping times in to a PUCCH. Thus, a UE using the technique 700 behaves the same whether or not there is a PUSCH scheduled, while a UE using the technique 750 behaves differently, depending on whether there is a PUSCH scheduled.

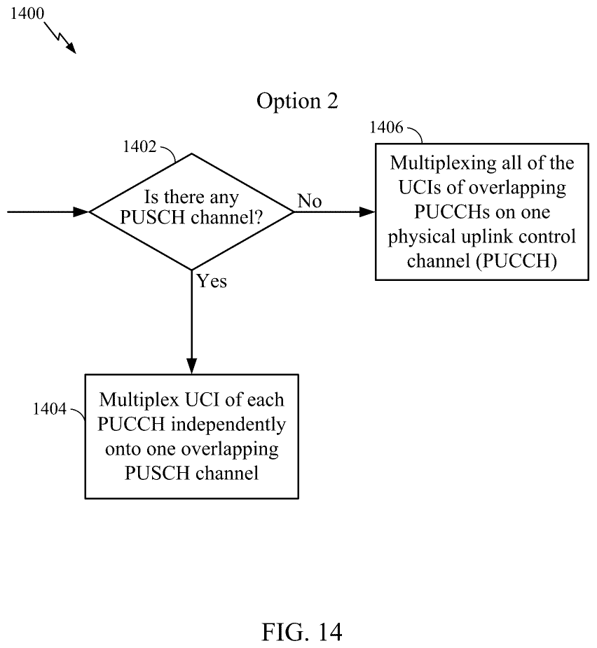

FIG. 14 provides a flow chart illustrating example operations 1400 for technique 750. At block 1402, the UE determines if it has a transmission for an allocation on a PUSCH in a time period. If so, the UE independently multiplexes each UCI independently on to an overlapping PUSCH channel, as shown at block 1404. If the UE does not have a transmission for an allocation on the PUSCH that overlaps any portion of a UCI, the UE multiplexes any overlapping UCIs onto one PUCCH, as shown at block 1406.

According to aspects of the present disclosure, when one PUCCH collides with (i.e., is to be transmitted in overlapping time periods with) multiple PUSCHs, the PUCCH may be multiplexed with any one of the PUSCHs.

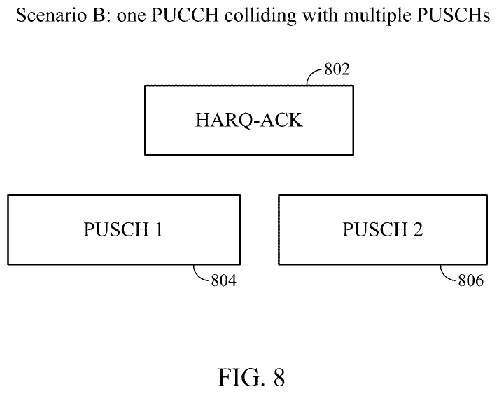

FIG. 8 is an exemplary scenario 800 in which a PUCCH 802 including HARQ-ACK UCI collides with a first PUSCH 804 and a second PUSCH 806. As mentioned above, in such a scenario, the PUCCH may be multiplexed with either one of the PUSCH 804 and the PUSCH 806.

In aspects of the present disclosure, a UE may multiplex UCI (e.g., PUCCHs, such as PUCCH 802) on the PUSCH with an earliest starting symbol (e.g., PUSCH 804). Considering the impact on an eNB UCI decoding timeline, it may be desirable to multiplex UCI on the PUSCH with an earliest starting symbol, when the UCI collides with multiple PUSCHs.

According to aspects of the present disclosure, a UE may multiplex UCI (e.g., PUCCHs, such as PUCCH 802) on the PUSCH whose grant is received earliest among all UL grants corresponding to PUSCHs colliding with the PUCCH. However, this option may delay the eNB UCI decoding, if the earliest grant points to a later PUSCH transmission, e.g., PUSCH 806 in FIG. 8.

In aspects of the present disclosure, when a UE is scheduled to transmit multiple UCIs that collide with multiple PUSCHs, the UE may multiplex the UCIs of overlapping PUCCHs on one PUCCH resource, as previously described. The UE may then, if the PUCCH overlaps in time with one or more PUSCHs, multiplex the PUCCH on the earliest overlapping PUCSH.

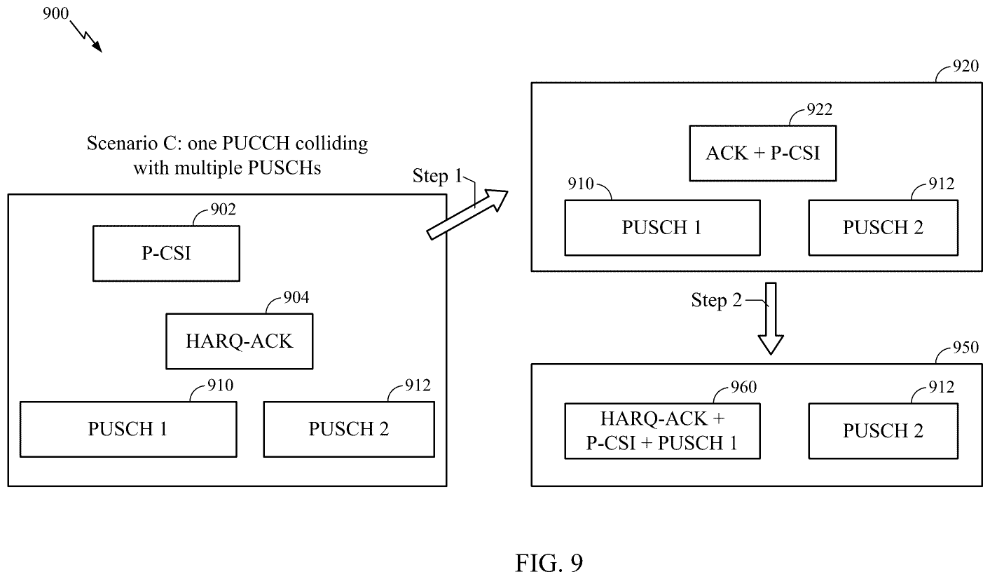

FIG. 9 illustrates an exemplary scenario 900, as described above. A UE (e.g., UE 120, shown in FIG. 1) is scheduled to transmit a first UCI 902 including periodic CSI, a second UCI 904 including a HARQ-ACK, a first PUSCH 910, and a second PUSCH 912. As illustrated, the first UCI overlaps the first PUSCH and the second UCI in time, and the second UCI overlaps the first PUSCH and the second PUSCH in time. In the exemplary scenario, the UE at 920 first multiplexes the overlapping UCIs on one PUCCH resource 922. Then, because the PUCCH resource 922 overlaps the first PUSCH and the second PUSCH, at 950 the UE multiplexes the UCIs on the earliest PUSCH that overlaps the PUCCH resource in time, which in the exemplary scenario is the first PUSCH. The multiplexed UCIs and first PUSCH are transmitted on the first PUSCH resources at 960, while the second PUSCH 912 is transmitted unchanged.

FIG. 10 illustrates operations 1000 for wireless communications, according to aspects of the present disclosure. The operations 1000 may be performed by a UE, such as UE 120, shown in FIG. 1.

Operations 1000 begin at block 1002 with the UE determining one or more uplink control informations (UCIs). For example, UE 120 (shown in FIG. 1) determines a first UCI including a HARQ-ACK and a second UCI including P-CSI.

At block 1004, operations 1000 continue with the UE obtaining one or more allocations of transmission resources for corresponding physical uplink shared channels (PUSCHs), wherein: a first period of a first allocation of the one or more allocations overlaps a second period during which at least a first UCI of the UCIs is to be transmitted, and the first period and the second period are different. Continuing the example from above, the UE 120 obtains (e.g., receives from a BS in a PDCCH) a first allocation of transmission resources for a first PUSCH and a second allocation of transmission resources for a second PUSCH, wherein a first period of the first allocation overlaps a second period during which the first UCI (from block 1002) is to be transmitted, and the first period and second period are different.

Operations 1000 continue at block 1006 with the UE multiplexing the at least the first UCI of the UCIs with the first PUSCH corresponding to the first allocation. Continuing the example from above, the UE multiplexes the first UCI (from block 1002) with the first PUSCH (from block 1004).

At block 1008, operations 1000 continue with the UE transmitting the multiplexed at least the first UCI and the first PUSCH corresponding to the first allocation via the transmission resources of the first allocation. Continuing the example from above, the UE transmits the multiplexed first UCI and the first PUSCH (from block 1006) via the transmission resources of the first allocation (from block 1004).

The previous techniques have all considered multiplexing UCI on PUSCH when neither the PUCCHs nor PUSCHs are being transmitted in repetitions, i.e., as part of a bundled transmission. According to aspects of the present disclosure, techniques for multiplexing UCI on PUSCH when PUCCHs and/or PUSCHs have repetitions over multiple slots are provided.

In aspects of the present disclosure, techniques are provided for multiplexing a PUCCH transmitted in a single slot that overlaps in time with a PUSCH transmitted in repetitions in multiple slots.

According to aspects of the present disclosure, techniques are provided for multiplexing a PUCCH transmitted in repetitions over multiple slots that overlap in time with a PUSCH transmitted in a single slot.

In aspects of the present disclosure, techniques are provided for multiplexing a PUCCH transmitted in repetitions over multiple slots that overlap in time with a PUSCH transmitted in repetitions in multiple slots.

According to aspects of the present disclosure, because the purpose of UCI repetition is typically to guarantee coverage of UCI (i.e., to guarantee the UCI is successfully received), it may be desirable to transmit the PUCCH channel with repetition and drop the rest of the channels (e.g., PUCCHs and PUSCHs scheduled to be transmitted without repetition).

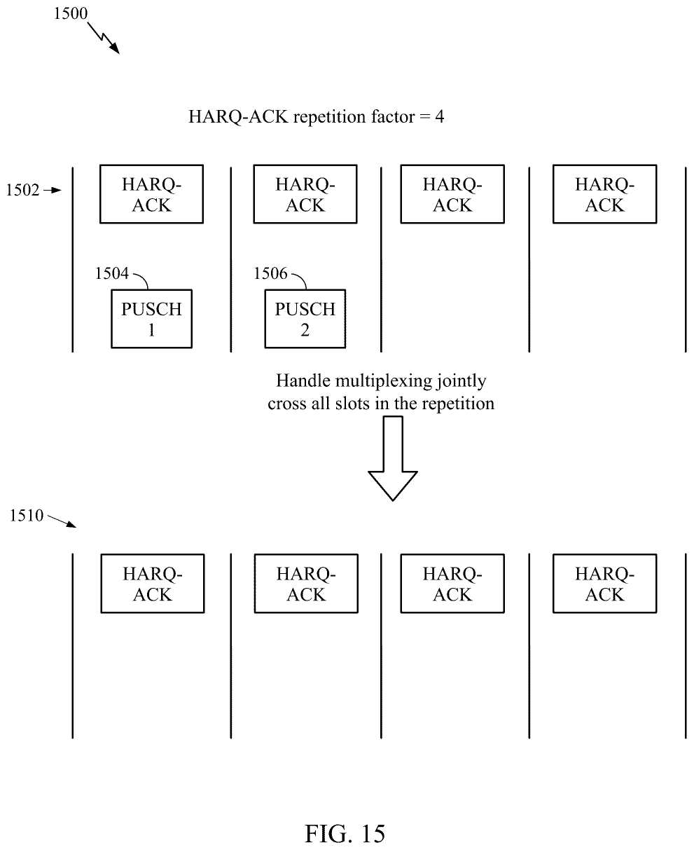

In aspects of the present disclosure, if a UE is scheduled to transmit a UCI with repetition, the UE may transmit the PUCCH with repetition and drop (i.e., not transmit) all other channels during the period of all of the repetitions of the PUCCH. FIG. 15 illustrates a technique 1500 for jointly multiplexing across all slots by respecting the repetition. In other words, the UE respects the repetition and does not behave differently once the repetition of a channel starts, i.e., UE does not break the PUCCH or PUSCH repetition. Furthermore, given that HARQ-ACK is typically considered important, it makes more sense to transmit the HARQ-ACK channel with repetition (if repetition is applied) and drop the rest of the channels. Thus, a UE that is scheduled with transmitting the HARQ-ACK channel with repetition, as shown at 1502, and also two PUSCHs 1504 and 1506 without repetition may transmit the HARQ-ACK channel with repetition and drop the PUSCHs 1504 and 1506, as shown at 1510.

According to aspects of the present disclosure, if a UE is scheduled to transmit two or more UCIs with repetition and one of the UCIs with repetition is the HARQ ACK channel, the UE may transmit the HARQ-ACK channel in a PUCCH with repetition and drop the rest of the channels during the period of all of the repetitions of the PUCCH.

In aspects of the present disclosure, if a UE is scheduled to transmit two or more UCIs with repetition and none of the UCIs with repetition is the HARQ ACK channel, the UE may transmit the channel of the UCI with a largest number of slots for repetition in a PUCCH repeated over that number of slots and drop the rest of the channels during the period of all of the repetitions of the PUCCH.

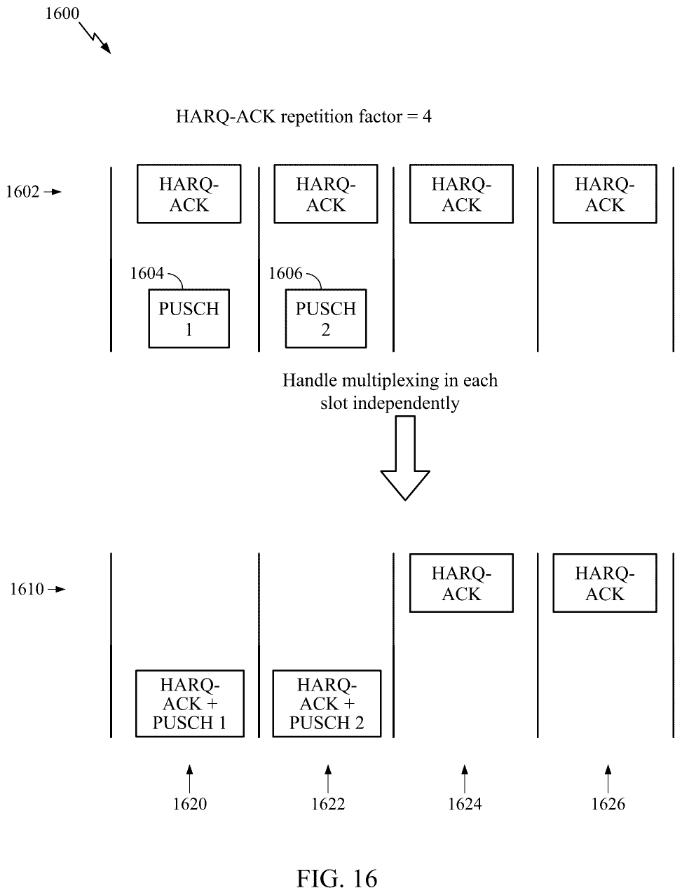

FIG. 16 illustrates an example 1600 of UCI multiplexing with slot repetition independently for each slot.

According to aspects of the present disclosure, if a UE is scheduled to transmit one or more UCIs with repetition and at least one of the repetitions overlaps in time with a PUSCH (which may be a PUSCH to be transmitted with repetition or without repetition), the UE may multiplex the UCI(s) with each other and with the PUSCH in each slot independently of other slots within the repetitions.

For example, a UE may be scheduled to transmit a PUCCH with 4 slot repetition (e.g., a HARQ-ACK with 4 slot repetition), as shown at 1602, that overlaps in time with PUSCHs 1604 and 1606 to be transmitted by the UE in 2 slots. In the example, at 1610 the UE multiplexes the UCI on PUSCH in 2 slots 1620 and 1622 and the UE transmits the UCI on PUCCH resources in 2 slots 1624 and 1626. In this manner, the UE independently handles multiplexing in each slot. The combining of UCI over 4 slots is complicated and the combining gain may be diminished (using the option illustrated in FIG. 16), which may reduce the coverage of PUCCH. However, the eNB allocating the resources for the UE to use for transmission has information regarding the coverage of the UE and can avoid scheduling PUSCH that collide with the 4-slot PUCCH repetition for the UE.

For enhanced mobile broadband (eMBB) communication techniques, in a PUCCH group, within overlapped PUCCH(s) or PUSCH(s) in a slot n, if the first symbol of the earliest PUCCH(s) or PUSCH(s) among all the overlapping channels starts no earlier than symbol N1+1 after the last symbol of PDSCH(s) in the slot, and if the first symbol of the earliest PUCCH(s) or PUSCH(s) among all the overlapping channels starts no earlier than N2+1 after the last symbol of PDCCHs scheduling UL transmissions including HARQ-ACK and PUSCH (if applicable), then:
(1) if none of the PUCCH(s) has UCI repetition configured, the UE may multiplex all UCIs on either one PUCCH or one PUSCH in slot n, using the existing UCI multiplexing rule,
(2) if one of the PUCCH(s) has UCI repetition configured, the UE may transmit the PUCCH channel with repetition and drop the rest of the channel(s) over the period of all of the repetitions, or
(3) if two of the PUCCHs have UCI repetition configured, the UE transmits the HARQ-ACK channel with repetition and drops the rest of the channel(s) over the period of all of the repetitions, if one of the PUCCHs with UCI repetition is the HARQ-ACK channel. If none of the PUCCHs with UCI repetition is a HARQ-ACK channel, then the UE transmits the channel having a largest number of slots for repetition (i.e., a largest number of repetitions) and drops the rest of the channel(s).

If at least one pair of overlapping channels does not meet the above timeline requirements, a UE may consider it to be an error case for all UL channels in the group of overlapping channels. The UE behavior may not be specified in any network standard. The definitions of N1 and N2 are the same definitions used in current (e.g., 5G) NR wireless communications specifications.

Overlapping channels include the determined PUCCH resource to transmit multiplexed multiple UCI types. For a PUCCH or a PUSCH with repetition, the first symbol of the channel may be defined as the first symbol in the first slot of the period of the repetition. The PUCCH(s) and PUSCH(s) described above may be with repetition or without repetition.

For eMBB, in a PUCCH group, when a multi-slot PUCCH(s) or PUSCH(s) overlap in a slot n, a UE may follow the above examples for single-slot PUCCH(s) or PUSCH(s) overlapping.

Another issue for consideration is how to handle overlapping UL parallel transmissions with PUCCH, PUSCH, SRS, and PRACH.

Above, options are presented regarding how to handle overlapped PUCCH(s) and PUSCH(s). However, in UL, other channel/signals such as SRS and PRACH may be transmitted. Therefore, aspects of the present disclosure provide techniques for addressing overlapped transmissions among PUCCH, PUSCH, PRACH, and SRS.

For clarity of the present disclosure, inter-band carrier aggregation (CA) and intra-band CA are distinguished. For UEs supporting inter-band CA, normally multiple power amplifiers (PAs) may be assumed. Therefore, parallel UL transmissions may be supported for inter-band CA. For intra-band CA, the common understanding is that only one PA is available at UE. Therefore, UL parallel transmissions may not be supported for intra-band CA. Aspects of the present disclosure focus on intra-band CA first.

According to aspects of the present disclosure, when timeline requirements for all overlapping UL channels in slot n are satisfied, if a UE also has PRACH or SRS to transmit in the overlapped channels, the UE may drop one or more channels based on rules described herein, since PRACH or SRS cannot be multiplexed on PUCCH or PUSCH.

In aspects of the present disclosure, for eMBB, in intra-band CA, when SRS or PRACH overlap with each other or SRS or PRACH overlap with PUCCH(s) or PUSCH(s) in slot n, the timeline requirements may be defined as the following.
(1) The first symbol of the earliest channel among all the overlapping channels starts no earlier than symbol N1+X after the last symbol of PDSCH(s), when one of the PUCCH includes HARQ-ACK; and
(2) The first symbol of the earliest channel among all the overlapping channels starts no earlier than N2+Y after the last symbol of PDCCHs scheduling UL transmissions including HARQ-ACK, PRACH, and PUSCH (if applicable) for slot n.

If at least one pair of overlapping channels does not meet the above timeline requirements, the UE may considers it to be an error case for all UL channels in the group of overlapping channels. The UE behavior may not be specified in any current network standards.

According to aspects of the present disclosure, if the timeline requirements are satisfied, the UE may transmit one channel and drop the rest of the channels in the group of overlapping channels.

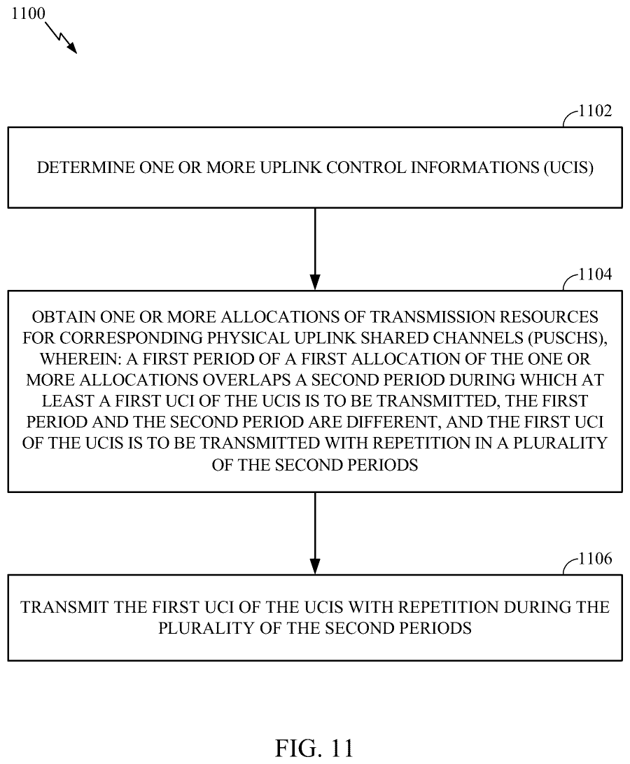

FIG. 11 illustrates exemplary operations 1100 for wireless communications, according to aspects of the present disclosure. The operations 1100 may be performed by a UE, for example UE 120 shown in FIG. 1.

Operations 1100 begin at block 1102 with the UE determining one or more uplink control informations (UCIs). For example, UE 120 (shown in FIG. 1) determines an UCI including a HARQ-ACK (e.g., the UCI shown at 1502 in FIG. 15).

At block 1104, operations 1100 continue with the UE obtaining one or more allocations of transmission resources for corresponding physical uplink shared channels (PUSCHs), wherein: a first period of a first allocation of the one or more allocations overlaps a second period during which at least a first UCI of the UCIs is to be transmitted, the first period and the second period are different, and the first UCI of the UCIs is to be transmitted with repetition in a plurality of the second periods. Continuing the example from above, the UE obtains two allocations of transmission resources for two PUSCHs (e.g., the allocations shown at 1504 and 1506 in FIG. 15), wherein a first period of the first allocation overlaps a second period during which the UCI from block 1102 is to be transmitted, the first period and the second period are different, and the UCI is to be transmitted with repetition in four of the second periods (e.g., four repetitions as shown at 1502 in FIG. 15).

Operations 1100 continue at block 1106 with the UE transmitting the first UCI of the UCIs with repetition during the plurality of the second periods. Continuing the example from above, the UE transmits the UCI from block 1102 with repetition during the four second periods (e.g., as shown at 1510 in FIG. 15).

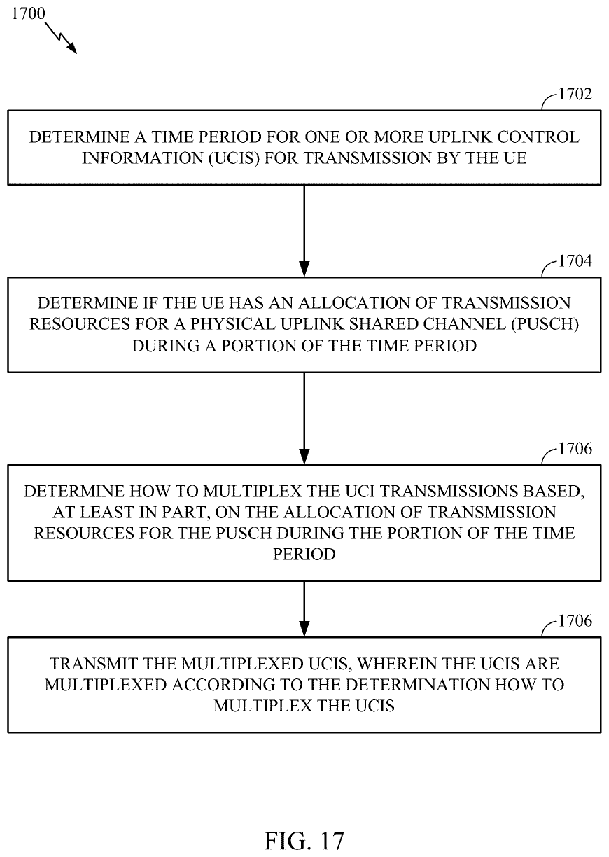

FIG. 17 illustrates exemplary operations 1700 for wireless communications, according to aspects of the present disclosure. The operations 1700 may be performed by a UE, for example UE 120 shown in FIG. 1.

At block 1702, the UE determines a time period for one or more uplink control informations (UCIs) for transmission by the UE. For example, UE 120 (shown in FIG. 1) determines a time period (e.g., the slot shown at 1620 in FIG. 16) for an UCI (e.g., the UCI shown at 1602 in FIG. 16) for transmission by the UE.

At block 1704, the UE determines if the UE has an allocation of transmission resources for a physical uplink shared channel (PUSCH) during a portion of the time period. Continuing the example from above, the UE determines that the UE has an allocation of transmission resources for a PUSCH (e.g., the allocation of transmission resources shown at 1604 in FIG. 16) during a portion of the time period from block 1702 (e.g., the slot shown at 1620 in FIG. 16).

At block 1706, the UE determines how to multiplex the UCIs based, at least in part, on the allocation of transmission resources for the PUSCH during the portion of the time period. As described in above with respect to FIG. 14, if a timing overlap exists, the UE may multiplex the UCI onto overlapping PUSCH transmissions. If no overlap exists, the UE may multiplex the UCIS onto a PUCCH channel. Continuing the example from above, the UE determines to multiplex the UCI with the PUSCH during the period (e.g., the slot shown at 1620 in FIG. 16) based, at least in part, on the allocation of transmission resources (e.g., the allocation of transmission resources shown at 1604 in FIG. 16) for the PUSCH during the portion of the time period (i.e., the time period from block 1702).

Operations 1700 continue at block 1708 with the UE transmitting the multiplexed UCIs, wherein the UCIs are multiplexed according to the determination how to multiplex the UCIs. Continuing the example from above, the UE transmits the multiplexed UCI, wherein the UCI is multiplexed with the PUSCH (e.g., as shown at 1620 in FIG. 16) according to the determination (i.e., the determination in block 1706) how to multiplex the UCIs.

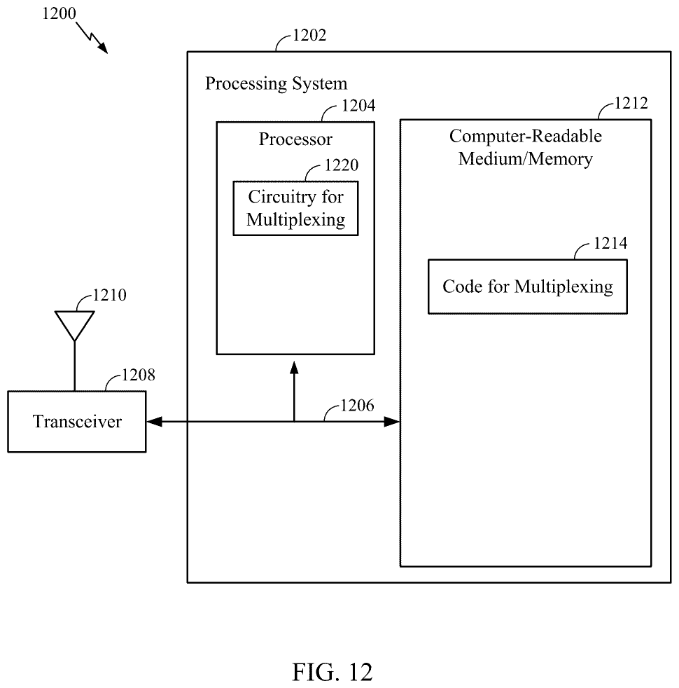

FIG. 12 illustrates a communications device 1200 that may include various components (e.g., corresponding to means-plus-function components) configured to perform operations for the techniques disclosed herein, such as the operations illustrated in FIGS. 10-11 and 17. The communications device 1200 includes a processing system 1202 coupled to a transceiver 1208. The transceiver 1208 is configured to transmit and receive signals for the communications device 1200 via an antenna 1210, such as the various signals described herein. For example, the transceiver 1208 may be configured to transmit a multiplexed UCI and PUSCH as described in FIG. 10, to transmit UCIs with repetition as described in FIG. 11, and/or to transmit multiplexed UCIs as described in FIG. 17. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions that when executed by processor 1204, cause the processor 1204 to perform the operations illustrated in FIGS. 10-11 and 17, or other operations for performing the various techniques discussed herein. The computer-readable medium/memory 1212 may store code 1214 for multiplexing that, when executed by the processor 1204, cause the processor to multiplex one or more UCIs with a PUSCH as described in FIG. 10 and/or multiplex UCIs as described in FIG. 17.

In certain aspects, the processor 1204 further includes circuitry 1220 for multiplexing one or more UCIs with a PUSCH as described in FIG. 10 and/or multiplexing UCIs as described in FIG. 17.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 10-11 and 17.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a user equipment (UE), comprising:
determining one or more uplink control informations (UCIs);
obtaining one or more allocations of transmission resources for corresponding physical uplink shared channels (PUSCHs), wherein:
a first period of a first allocation of the one or more allocations overlaps a second period during which at least a first UCI of the UCIs is to be transmitted,
the first period and the second period are different, and
the first UCI of the UCIs is to be transmitted with repetition in a plurality of the second periods; and
transmitting the first UCI of the UCIs with repetition during the plurality of the second periods.

2. The method of claim 1, wherein:
a plurality of second UCIs of the UCIs is to be transmitted with repetition during a plurality of third periods,
at least one of the third periods overlaps at least one of the second periods, and the method further comprises:
determining to transmit the first UCI based on the first UCI being a hybrid automatic retransmission request acknowledgment (HARQ-ACK) channel; and
dropping the plurality of the second UCIs during the plurality of the third periods.

3. The method of claim 1, wherein:
a plurality of second UCIs of the UCIs is to be transmitted with repetition during a plurality of third periods,
at least one of the third periods overlaps at least one of the second periods, and the method further comprises:
determining to transmit the first UCI based on there being more second periods in the plurality of the second periods than there are third periods in the plurality of the third periods; and
dropping the plurality of the second UCIs during the plurality of the third periods.

4. The method of claim 1, further comprising dropping the PUSCHs during the plurality of the second periods.

5. The method of claim 1, further comprising dropping UCIs that are not to be transmitted with repetition during the plurality of the second periods.

6. The method of claim 1, wherein:
the one or more allocations of the transmission resources for the corresponding PUSCHs comprises a plurality of the first allocations for a plurality of first PUSCHs,
the first PUSCHs are to be transmitted with repetition during a plurality of the first periods:
multiplexing, during each of the plurality of the first periods, the at least the first UCI of the UCIs with one of the first PUSCHs; and
transmitting, during each of the plurality of the first periods, the multiplexed at least the first UCI and the one of the first PUSCHs via the transmission resources of the first allocation.

7. An apparatus for wireless communications at a user equipment (UE), comprising:
at least one memory comprising computer-executable instructions; and
one or more processors configured to execute the computer-executable instructions and cause the apparatus to:
determine one or more uplink control informations (UCIs);
obtain one or more allocations of transmission resources for corresponding physical uplink shared channels (PUSCHs), wherein:
a first period of a first allocation of the one or more allocations overlaps a second period during which at least a first UCI of the UCIs is to be transmitted,
the first period and the second period are different, and
the first UCI of the UCIs is to be transmitted with repetition in a plurality of the second periods; and
transmit the first UCI of the UCIs with repetition during the plurality of the second periods.

8. The apparatus of claim 7, wherein:
a plurality of second UCIs of the UCIs is to be transmitted with repetition during a plurality of third periods,
at least one of the third periods overlaps at least one of the second periods, and the one or more processors are further configured to cause the apparatus to:
determine to transmit the first UCI based on the first UCI being a hybrid automatic retransmission request acknowledgment (HARQ-ACK) channel; and
drop the plurality of the second UCIs during the plurality of the third periods.

9. The apparatus of claim 7, wherein:
a plurality of second UCIs of the UCIs is to be transmitted with repetition during a plurality of third periods,
at least one of the third periods overlaps at least one of the second periods, and the one or more processors are further configured to cause the apparatus to:
determine to transmit the first UCI based on there being more second periods in the plurality of the second periods than there are third periods in the plurality of the third periods; and
drop the plurality of the second UCIs during the plurality of the third periods.

10. The apparatus of claim 7, wherein the one or more processors are further configured to cause the apparatus to drop the PUSCHs during the plurality of the second periods.

11. The apparatus of claim 7, wherein the one or more processors are further configured to cause the apparatus to drop UCIs that are not to be transmitted with repetition during the plurality of the second periods.

12. The apparatus of claim 7, wherein:
the one or more allocations of the transmission resources for the corresponding PUSCHs comprises a plurality of the first allocations for a plurality of first PUSCHs,
the first PUSCHs are to be transmitted with repetition during a plurality of the first periods, wherein the one or more processors are further configured to cause the apparatus to:
multiplex, during each of the plurality of the first periods, the at least the first UCI of the UCIs with one of the first PUSCHs; and
transmit, during each of the plurality of the first periods, the multiplexed at least the first UCI and the one of the first PUSCHs via the transmission resources of the first allocation.

13. A non-transitory computer readable medium for wireless communication by a user equipment (UE), comprising:
instructions that, when executed by one or more processors of an apparatus, cause the apparatus to:
determine one or more uplink control informations (UCIs);
obtain one or more allocations of transmission resources for corresponding physical uplink shared channels (PUSCHs), wherein:
a first period of a first allocation of the one or more allocations overlaps a second period during which at least a first UCI of the UCIs is to be transmitted,
the first period and the second period are different, and
the first UCI of the UCIs is to be transmitted with repetition in a plurality of the second periods; and
transmit the first UCI of the UCIs with repetition during the plurality of the second periods.

14. The non-transitory computer readable medium of claim 13, wherein:
a plurality of second UCIs of the UCIs is to be transmitted with repetition during a plurality of third periods,
at least one of the third periods overlaps at least one of the second periods, and the instructions further cause the apparatus to:
determine to transmit the first UCI based on the first UCI being a hybrid automatic retransmission request acknowledgment (HARQ-ACK) channel; and
drop the plurality of the second UCIs during the plurality of the third periods.

15. The non-transitory computer readable medium of claim 13, wherein:
a plurality of second UCIs of the UCIs is to be transmitted with repetition during a plurality of third periods,
at least one of the third periods overlaps at least one of the second periods, and the instructions further cause the apparatus to:
determine to transmit the first UCI based on there being more second periods in the plurality of the second periods than there are third periods in the plurality of the third periods; and
drop the plurality of the second UCIs during the plurality of the third periods.

16. The non-transitory computer readable medium of claim 13, wherein the instructions further cause the apparatus to drop the PUSCHs during the plurality of the second periods.

17. The non-transitory computer readable medium of claim 13, wherein the instructions further cause the apparatus to drop UCIs that are not to be transmitted with repetition during the plurality of the second periods.

18. The non-transitory computer readable medium of claim 13, wherein:
the one or more allocations of the transmission resources for the corresponding PUSCHs comprises a plurality of the first allocations for a plurality of first PUSCHs,
the first PUSCHs are to be transmitted with repetition during a plurality of the first periods, wherein the instructions further cause the apparatus to:
multiplex, during each of the plurality of the first periods, the at least the first UCI of the UCIs with one of the first PUSCHs; and
transmit, during each of the plurality of the first periods, the multiplexed at least the first UCI and the one of the first PUSCHs via the transmission resources of the first allocation.
